(19) United States
(12) Patent Application Publication
(10) Pub. No.: US 2022/0161187 A1
(43) Pub. Date: May 26, 2022

(54) SMART DEHUMIDIFICATION APPARATUS AND DEHUMIDIFICATION METHOD OF FLOW RATE-DEPENDENT SWITCHING METHOD

(71) Applicant: KD ENS CO., LTD., Anyang-si (KR)

(72) Inventor: Jong Chan LEE, Yongin-si (KR)

(73) Assignee: KD ENS CO., LTD., Anyang-si (KR)

(21) Appl. No.: 17/440,187

(22) PCT Filed: Mar. 23, 2020
(86) PCT No.: PCT/KR2020/003941

§ 371 Date: Sep. 17, 2021

(30) Foreign Application Priority Data
Mar. 21, 2019 (KR) 10-2019-0032420

(51) Int. Cl. B01D 53/26; B01D 53/04

(52) U.S. Cl. CPC B01D 53/261; B01D 53/0454; B01D 2259/40088; B01D 2259/40003; B01D 53/0438

(57) ABSTRACT

The present invention relates to a smart dehumidification apparatus and dehumidification method of a flow rate-dependent switching method. The present invention provides an adsorption-type dehumidification apparatus and a dehumidification method using same, the adsorption-type dehumidification apparatus comprising: a first adsorption tower (A) and a second adsorption tower (B) which are two adsorption towers filled with adsorbents and which alternately perform a dehumidification process and a regeneration process; an inflow line (10) for introducing a humidified gas into the first adsorption tower (A) and the second adsorption tower (B); a discharge line (20) for discharging a dried gas dehumidified in the first adsorption tower (A) and the second adsorption tower (B); a regeneration line (30) for introducing a regeneration gas into the first adsorption tower (A) and the second adsorption tower (B); a heater (40) for heating the regeneration gas; a flow meter (F) for measuring the flow rate of the humidified gas flowing into the first adsorption tower (A) and the second adsorption tower (B); and a control unit (C). According to the present invention, the moisture contained in compressed air, etc., is dried through adsorption and regeneration, and the dehumidification process (adsorption process) and the regeneration process are switched depending on the flow rate of the humidified gas flowing into the adsorption towers (A, B) such that at least the renewable energy consumed in the regeneration process can be reduced.

### TECHNICAL FIELD

The present invention relates to a smart dehumidification apparatus and dehumidification method of a flow rate-dependent switching method. According to an embodiment, the present invention provides a smart dehumidification apparatus of a flow rate-dependent switching method and a dehumidification method using same, in which compressed air is dried by adsorbing and removing the moisture contained in the compressed air through a dehumidification process (adsorption) and a regeneration process, and thus at least energy can be reduced by switching the dehumidification process and the regeneration process depending on the flow rate of the compressed air.

### BACKGROUND ART

In general, the gas containing moisture is being dried, and examples thereof include compressed air (Air), nitrogen (N2) and oxygen (O2). Moisture adversely affects storage facilities of the moisture-containing gas or facilities using same.

For example, compressed air is used in almost all industries such as machinery, semiconductors, electronics, and chemistry. Compressed air is mainly used as a power source for pneumatic machinery and the like. Most of the compressed air that is industrially used is produced by compressing air in the atmosphere by using a compressor or the like. Such compressed air contains moisture, dust, and pollutants in the atmosphere, and if used as it is, malfunctioning of equipment may occur. In particular, moisture may cause rust or corrosion in machinery and semiconductor manufacturing equipment, and thus shortens the lifespan.

Accordingly, compressed air is used after removing moisture through dehumidification, and most facilities that use compressed air are equipped with a dehumidifying apparatus. The dehumidification apparatus is usually called an air dryer, which is classified into a refrigeration type, an absorption type, and an adsorption type according to a method of removing moisture. Among those dehumidification apparatuses, the mainstream is an adsorption-type dehumidification apparatus. For example, a technology for an adsorption-type dehumidification apparatus is suggested in Korean Patent Registration No. 10-0793980, Korean Patent No. 10-1957260, and Korean Patent Registration No. 10-1954772, etc.

The adsorption-type dehumidification apparatus includes two adsorption towers filled with a porous adsorbent. Of the two adsorption towers, one adsorption tower performs a dehumidification process (adsorption process) while the other adsorption tower performs a regeneration process (desorption process). In addition, according to the time set by means of a timer, the two adsorption towers are switched in opposite processes. That is, on the basis of a predetermined (set) time, the adsorption tower (dehumidification tower) that has completed the dehumidification process is switched to the regeneration process, and at the same time, the adsorption tower (regeneration tower) that has completed the regeneration process is switched to the dehumidification process. The two adsorption towers continuously produce dry compressed air by alternating dehumidification and regeneration through tower switching. The adsorption-type dehumidification apparatus continuously dehumidifies by alternately repeating dehumidification and regeneration in two adsorption towers, resulting in high compressed air productivity and dehumidification efficiency.

However, the conventional adsorption-type dehumidification apparatus and the dehumidifying method using same have a problem in that more renewable energy than necessary is consumed.

In general, the adsorption-type dehumidification apparatus adsorption-type dehumidification apparatus installed in almost all industrial sites is designed and manufactured with a margin of about 20 to 30% by volume compared to the actual usage. In addition, the adsorption-type dehumidification apparatus is designed such that dry compressed air corresponding to about 10% by volume of the design production is to be used in the regeneration process. Accordingly, in the regeneration process, 10% by volume of compressed air production energy (energy consumed by a compressor, etc.) is required, and in addition to this, power energy of a heater for heating the dry compressed air is required. Therefore, in the regeneration process, the renewable energy obtained by adding 10 vol % of compressed air production energy and the electric power energy of the heater is required.

Since the amount of adsorbent filled in the adsorption tower (regeneration tower) is constant, the initially designed renewable energy is required to regenerate the adsorbent, and thus the amount of renewable energy is not changed even if actual usage is reduced. That is, the amount of the adsorbent filled in the adsorption tower (regeneration tower) is fixed at a predetermined amount initially designed, for example, even if the operation needs to be reduced according to the field conditions of the plant, in order to regenerate the adsorbent, the initially designed renewable energy is required regardless of the amount of reduction in operation. Even when the operation needs to be reduced in such a manner, the consumption of renewable energy does not change, and more renewable energy than necessary is consumed.

In addition, the utilization of the adsorbent is poor. That is, even though the adsorbent filled in the adsorption tower (dehumidification tower) of the dehumidification process still has dehumidification performance, the tower switching is performed by a predetermined time and regeneration is performed in a state where the regeneration performance is not fully achieved. Accordingly, the utilization of the adsorbent is low, and the lifespan is reduced.

### DESCRIPTION OF EMBODIMENTS

### Technical Problem

Accordingly, an objective of the present invention is to provide an improved adsorption-type dehumidification apparatus and a dehumidifying method.

According to one embodiment, the present invention provides a smart dehumidification apparatus of a flow rate-dependent switching method and a. dehumidification method using same, in which compressed air is dried by adsorbing and removing the moisture contained in the compressed air through a dehumidification process and a regeneration process, and thus at least energy can be reduced and the utilization and lifespan of an adsorbent can be improved, by switching the dehumidification process and the regeneration process depending on the flow rate of the compressed air.

### Solution to Problem

To achieve the above objective, the present invention provides an adsorption-type dehumidification apparatus of moisture-containing gas, comprising:

a first adsorption tower (A) and a second adsorption tower (B) which are two adsorption towers filled with adsorbents and which alternately perform a dehumidification process and a regeneration process;

an inflow line (10) for introducing a humidified gas into the first adsorption tower and the second adsorption tower (B);

a discharge line (20) for discharging a dried gas dehumidified in the first adsorption tower (A) and the second adsorption tower (B);

a regeneration line (30) for introducing a regeneration gas into the first adsorption tower (A) and the second adsorption tower (B);

a heater (40) for heating the regeneration gas;

a flow meter (F) for measuring the flow rate of the humidified gas flowing into the first adsorption tower (A) and the second adsorption tower (B); and

a control unit (C).

Here, the control unit (C), depending on the flow rate measured by the flow meter (F), switches the dehumidification process and the regeneration process performed in the first adsorption tower (A) and the second adsorption tower (B).

In addition, the present invention provides a dehumidification method of a moisture-containing gas, comprising:

a process for alternately carrying out continuously a dehumidification process and a regeneration process through two adsorption towers,

in which, of the two adsorption towers, one adsorption tower performs the dehumidification process while the other adsorption tower performs the regeneration process; and

a tower switching process in which the dehumidification process and the regeneration process performed in the two adsorption towers are switched,

wherein the tower switching process is performed depending on the flow rate of the humidified gas flowing into the adsorption tower in which the dehumidification process is performed.

Additionally, the present invention provides a dehumidification method of a moisture-containing gas, which uses

the dehumidification apparatus of moisture-containing gas, according to the present invention, and comprises:

a dehumidification process performed in the first adsorption tower;

a regeneration process performed in the second adsorption tower while the dehumidification process is performed in the first adsorption tower;

a standby process in which a dehumidification process is performed in the first adsorption tower, but a regeneration process is not performed in the second adsorption tower; and

a tower switching process in which the first adsorption tower is switched to perform a regeneration process, and the second adsorption tower is switched to perform a dehumidification process,

wherein the tower switching process is performed depending on the flow rate of the humidified gas flowing into the first adsorption tower in which the dehumidification process is performed.

### Advantageous Effects of Disclosure

According to the present invention, the dehumidification process and the regeneration process are switched depending on the flow rate, and thus at least renewable energy can be reduced, and the utilization and lifespan of the adsorbent can be improved.

### BRIEF DESCRIPTION OF DRAWINGS

FIG. 1 is a block diagram of an adsorption-type dehumidification apparatus according to an embodiment of the present invention.

FIG. 2 is a block diagram of an adsorption-type dehumidification apparatus according to an embodiment of the present invention, for explaining a dehumidification process.

FIG. 3 is a block diagram of an adsorption-type dehumidification apparatus according to an embodiment of the present invention, for explaining a regeneration process.

### DETAILED DESCRIPTION

As used herein, the term “and/or” is used to mean including at least one or more of the components listed before and after. As used herein, the terms “first”, “second”, “one side” and “other side” are used to distinguish one component from another component, and each component is not limited to be defined thereby.

Hereinafter, the present invention will be described with reference to the accompanying drawings. The accompanying drawings show exemplary embodiments of the present invention, which are provided merely to aid understanding of the present invention. In addition, in the accompanying drawings, the thickness may be enlarged in order to clearly express each component and region, and the scope of the present invention is not limited by the thickness, size, and ratio indicated in the drawings. Hereinafter, in describing the present invention, detailed descriptions of related known general-purpose functions and/or configurations will be omitted.

The present invention provides an adsorption-type dehumidification apparatus for removing (drying) moisture contained in a moisture-containing gas, such as compressed air (hereinafter, abbreviated as “dehumidification apparatus”), and a method for dehumidifying a moisture-containing gas using same (hereinafter, “dehumidification method”). In addition, the present invention provides a method for controlling the operation of the dehumidification apparatus.

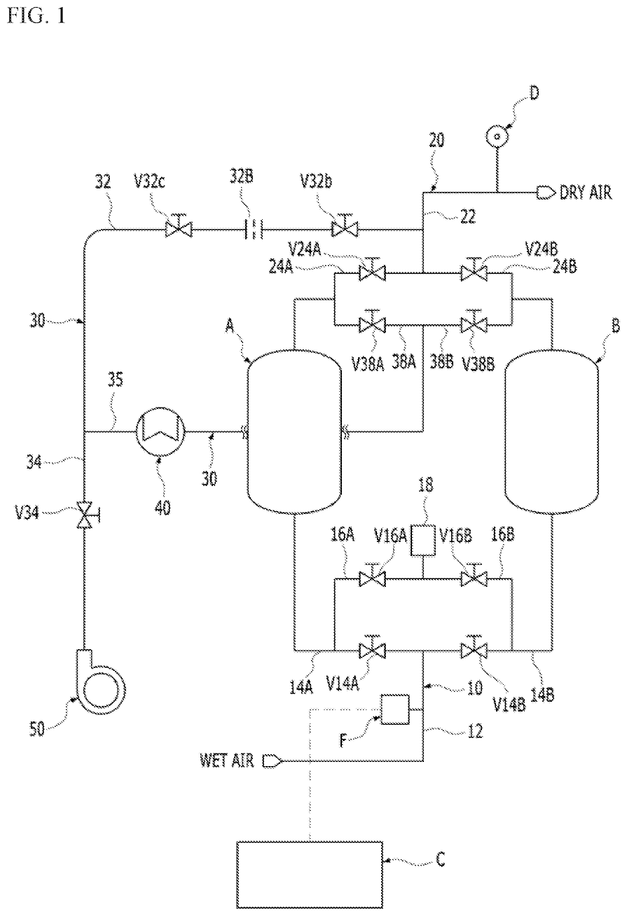

FIG. 1 is a block diagram of an adsorption-type dehumidification apparatus according to an embodiment of the present invention.

The dehumidification apparatus according to an embodiment of the present invention includes a first adsorption tower A and a second adsorption tower B which are two adsorption towers filled with adsorbents and which alternately perform a dehumidification process and a regeneration process; an inflow line 10 for introducing a humidified gas into the first adsorption tower A and the second adsorption tower B; a discharge line 20 for discharging a dried gas dehumidified in the first adsorption tower A and the second adsorption tower B; a regeneration line 30 for introducing a regeneration gas into the first adsorption tower A and the second adsorption tower B; a heater 40 for heating the regeneration gas; a flow meter F for measuring the flow rate of the humidified gas flowing into the first adsorption tower A and the second adsorption tower B; and a control unit C.

In addition, the dehumidification apparatus according to an embodiment of the present invention may include a plurality of valves V14A to V34 for controlling the flow of gas in each of the lines 10, 20 and 30. Additionally, the dehumidification apparatus according to an embodiment of the present invention may further include an external air supply means 50 for supplying an external gas, a dew-point meter D and/or a filter (not shown) for measuring the dew point of the dried gas, etc., which are optional components.

The dehumidification method according to the present invention includes: a process for alternately carrying out continuously a dehumidification process (adsorption process) and a regeneration process through two adsorption towers A and B, in which, of the two adsorption towers A and B, one of the adsorption towers A and B performs the dehumidification process while the other of the adsorption towers A and B performs the regeneration process; and a tower switching process in which the dehumidification process and the regeneration process performed in the two adsorption towers A and B are switched, wherein the tower switching process is performed depending on the flow rate of the humidified gas flowing into the adsorption tower in which the dehumidification process is performed.

In the present invention, the moisture-containing gas to be dehumidified is not particularly limited as long as moisture is contained therein, and examples thereof include compressed air, nitrogen (N₂) and/or oxygen (O₂). The following description will be made by using compressed air obtained by compressing air in the atmosphere by means of a compressor, etc., as the moisture-containing gas. In addition, the external gas supplied through the external air supply means 50 may be air and/or nitrogen (N₂), for example. Hereinafter, air in the atmosphere (in some cases, referred to as “external air”) will be described with respect to the external gas by way of example.

The two adsorption towers A and B are filled with an adsorbent inside a vessel. The two adsorption towers A and B continuously alternately perform the dehumidification process (adsorption process) and the regeneration process. Of the two adsorption towers A and B, one adsorption tower A or B performs a dehumidification process (adsorption process) while the other adsorption tower A or B performs a regeneration process. Specifically, when the first adsorption tower A performs the dehumidification process, the second adsorption tower B performs the regeneration process at the same time. Thereafter, through tower switching, the first adsorption tower A is switched to perform a regeneration process, and at the same time, the second adsorption tower B is switched to perform a dehumidification process, and this procedure is alternately repeated.

As the adsorbent, any adsorbent that is capable of adsorbing moisture contained in compressed air may be used, and a commonly used adsorbent may be used. The adsorbent may be selected from, for example, alumina, silica, alumina-silica and/or molecular sieves, but is not limited thereto. In addition, the adsorbent may have a shape such as, for example, a bead, a pellet, and/or a flake.

The inflow line 10 introduces compressed air and supplies it to the adsorption towers A and B. The inflow line 10 is, for example, a main inflow pipe 12 connected to a compressor, etc., and two branch inflow pipes 14A and 14B branched from the main inflow pipe 12, and first and second branch inflow pipes 14A and 14B. Here, the first branch inflow pipe 14A is connected to the first adsorption tower A, and the second branch inflow pipe 14B is connected to the second adsorption tower B.

In addition, inflow valves V14A and V14B for opening/closing may be installed on the inflow line 10. Specifically, the first inflow valve V14A may be installed in the first branch inflow pipe 14A, and a second inflow valve V14B may be installed in the second branch inflow pipe 14B. For example, when the first adsorption tower A performs a dehumidification process and the second adsorption tower B performs a regeneration process, the first inlet valve V14A is opened and the second inlet valve V14B is closed.

In addition, referring to FIG. 1, a first purging pipe 16A and a second purging pipe 16B, which are purging pipes 16A and 16B for discharging the regeneration gas to the outside, may be connected to the inflow line 10. Here, the first purging pipe 16A may be branched and connected to a first branch inflow pipe 14A, and the second purging pipe 16B may be branched and connected to a second branch inflow pipe 14B. In addition, a first purging valve V16A may be installed in the first purging pipe 16A, and a second purging valve V16B may be installed in the second purging pipe 16B. Additionally, the purging pipes 16A and 16B may be connected to a silencer 18 for reducing noise by reducing the flow rate of the regeneration gas discharged to the outside.

The discharge line 20 discharges the dehumidified dry compressed air from the adsorption towers A and B. The discharge line 20 includes a first branch discharge pipe 24A through which the dry compressed air dehumidified from the first adsorption tower A is discharged, a second branch discharge pipe 24B through which the dry compressed air dehumidified from the second adsorption tower B is discharged, and a main discharge pipe 22 in which the first branch discharge pipe 24A and the second branch discharge pipe 24B are joined. In addition, discharge valves V24A and V24B for opening/closing may be installed on the discharge line 20. Specifically, a first discharge valve V24A may be installed in the first branch discharge pipe 24A, and a second discharge valve V24B may be installed in the second branch discharge pipe 24B. For example, when the first adsorption tower A performs a dehumidification process and the second adsorption tower B performs a regeneration process, the first discharge valve V24A is opened and the second discharge valve V24B is closed.

The regeneration line 30 introduces regeneration gas and supplies the same to the adsorption towers A and B. That is, the regeneration line 30 supplies the regeneration gas to any one of the two adsorption towers A and B undergoing regeneration process. Here, the regeneration gas may be selected from dry compressed air and/or external air (air or nitrogen) dehumidified in the adsorption towers A and B. The regeneration line 30 may include at least one selected from the dry compressed air inflow pipe 32 and an external air inflow pipe 34. In addition, the regeneration line 30 includes supply pipes 38A and 38B for supplying the regeneration gas introduced from the inflow pipes 32 and 34 to the adsorption towers A and B.

Specifically, the regeneration line 30 may include inflow pipes 32 and 34 for introducing at least one regeneration gas selected from dry compressed air and external air, and the regeneration gas introduced from the inflow pipes 32 and 34, respectively. In addition, the supply pipes 38A and 38B may include a first supply pipe 38A for supplying regeneration gas to the first adsorption tower A, and a second supply pipe 38B for supplying regeneration gas to the second adsorption tower B. Additionally, regeneration valves V38A and V38B for opening and closing may be installed in the supply pipes 38A and 38B, respectively. That is, a first regeneration valve V38A may be installed in the first supply pipe 38A, and a second regeneration valve V38B may be installed in the second supply pipe 38B. For example, when the first adsorption tower A performs a dehumidification process and the second adsorption tower B performs a regeneration process, the first regeneration valve V38A is closed and the second regeneration valve V38B is opened.

As shown in FIG. 1, the regeneration line 30 may include both of the dry compressed air inflow pipe 32 and the external air inflow pipe 34. At this time, the regeneration line 30 includes a regeneration confluence pipe 35 through which the dry compressed air inflow pipe 32 and the external air inflow pipe 34 are joined, and which is connected to the supply pipes 38A and 38B.

The dry compressed air inflow pipe 32 is connected to the discharge line 20 to introduce some of the dry compressed air dehumidified in the adsorption towers A and B. The dry compressed air inflow pipe 32 may include a flow control valve V32b, an orifice 32B and/or a pressure reducing valve V32c. The flow control valve V32b controls the flow rate of the dry compressed air flowing in from the discharge line 20. In addition, the orifice 32B regulates the flow rate of dry compressed air and adiabatically expands. In addition, the pressure reducing valve V32c reduces the pressure of dry compressed air.

The dry compressed air passing through the dry compressed air inflow pipe 32 can be maintained at an appropriate flow rate and an appropriate pressure through the flow control valve V32b, the orifice (32B) and the pressure reducing valve V32c. For example, through the flow control valve V32b, about 8 to 20% of the flow rate of air discharged to the discharge line 20 may be introduced into the dry compressed air inflow pipe 32. In addition, for example, when the adsorption towers A and B undergoing the regeneration process are operated at 7.0 kg/cm² (operating pressure), the dry compressed air passing through the dry compressed air inflow pipe 32 can be maintained at a pressure of 1.0 to 3.0 kg/cm².

The external air inflow pipe 34 introduces external air. Here, the external air inflow pipe 34 may be provided with an external air supply means 50. The external air supply means 50 may be selected from, for example, a blower or a fan that sucks and supplies air in the atmosphere. In addition, an external air valve V34 for opening and closing the flow of external air may be installed in the external air inflow pipe 34.

The heater 40 is not particularly limited as long as it can heat the regeneration gas, and may be selected from, for example, an electric heater and/or a steam heater. The heater 40 is installed on the regeneration line 30, which may be specifically installed on the regeneration confluence pipe 35 as shown in FIG. 1.

The flow meter F measures the flow rate of compressed air (before dehumidification) flowing into the adsorption towers A and B. The flow meter F is not particularly limited as long as it can measure the flow rate of compressed air, which may be, for example, an electromagnetic flow meter. The flow meter F is installed in the inflow line 10. Specifically, the flow meter F may be installed in the main inflow pipe 12 or installed in the two branch inflow pipes 14A and 14B, respectively. FIG. 1 shows an example state in which the flow meter F is installed in the main inflow pipe 12.

The dew-point meter D measures the dew point of the dry compressed air, and may measure the dew point of the dry compressed air by sampling the dry compressed air discharged to the discharge line 20. The dew-point meter D may be installed to be connected to, for example, the discharge line 20, but not particularly limited thereto. The dew-point meter D may be any meter that can measure the content of moisture contained in the dry compressed air and can display the numerical value thereof as a dew point unit (e.g., −40° C., etc.).

The control unit C controls all operations of the dehumidification apparatus and operation in an emergency. The control unit C may include components used in general industrial fields, such as mechanical equipment and electronic equipment, including those in the related art. The control unit C may include, for example, a detection sensor, a timer, a controller, and a display device, and the controller may include a programmable logic controller (PLC) and/or a printed circuit board (PCB). This control unit C controls, for example, the operation of the valves V14A to V34 installed on the respective lines 10, 20 and 30, the operating time of the adsorption towers A and B, the tower switching of the adsorption towers A and B, and so on. Here, the control unit C controls tower switching of the adsorption towers A and B depending on the flow rate measured by the flow meter F.

The filter may be installed at the front and/or rear ends of the adsorption towers A and B, as long as foreign substances (solids) contained in the compressed air can be filtered. The filter, for example, may be installed in one or more selected from the inflow line 10 and the discharge line 20. According to one embodiment, the filter may include a front-end filter installed in the inflow line 10 and a rear-end filter installed in the discharge line 20.

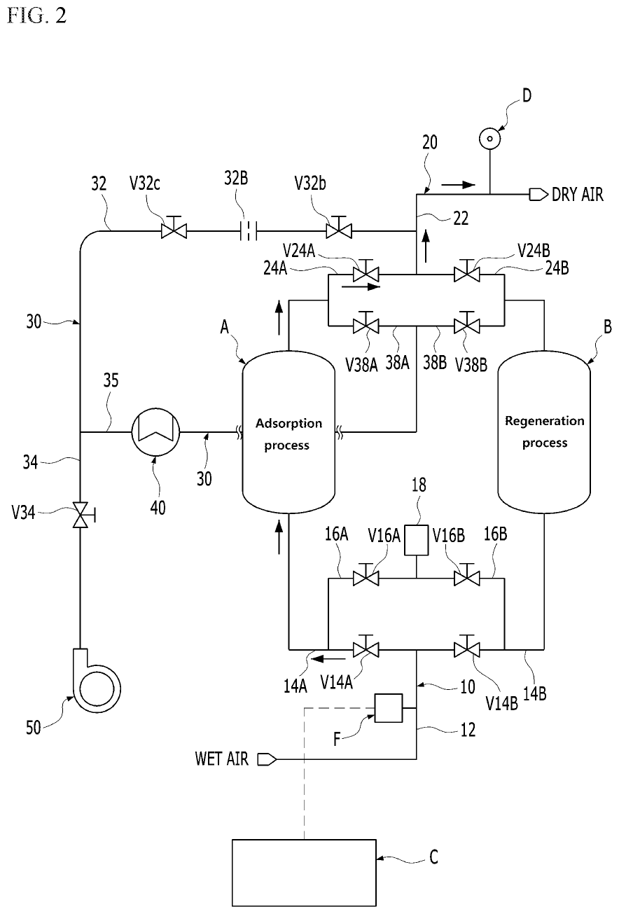

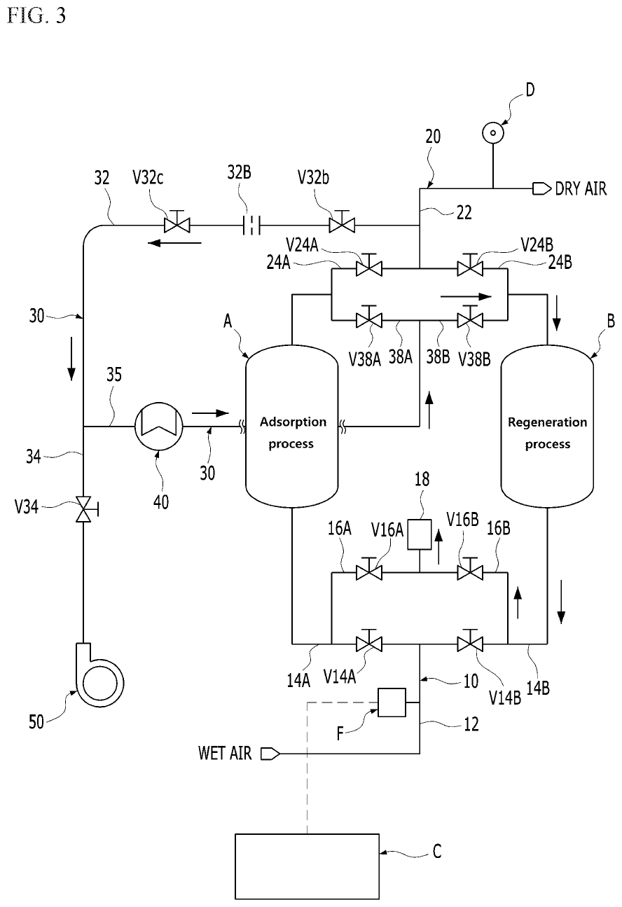

Hereinafter, an embodiment of a dehumidification method according to the present invention will be described with reference to FIGS. 2 and 3. The following dehumidification method is described with respect to a case where the first adsorption tower A performs the dehumidification process and the second adsorption tower B performs the regeneration process by way of example. In addition, through the following dehumidification method, an operation control method of the dehumidification apparatus according to an embodiment of the present invention will also be described.

FIG. 2 is a block diagram of an adsorption-type dehumidification apparatus according to an embodiment of the present invention, for explaining a dehumidification process. FIG. 3 is a block diagram of an adsorption-type dehumidification apparatus according to an embodiment of the present invention, for explaining a regeneration process. The arrows shown in FIGS. 2 and 3 indicate the flow of compressed air.

The dehumidification method according to the present invention, in which the dehumidification apparatus of moisture-containing gas, according to the present invention, is used, comprises: a dehumidification process performed in the first adsorption tower; a regeneration process performed in the second adsorption tower while the dehumidification process is performed in the first adsorption tower; a standby process in which a dehumidification process is performed in the first adsorption tower, but a regeneration process is not performed in the second adsorption tower; and a tower switching process in which the first adsorption tower is switched to perform a regeneration process, and the second adsorption tower is switched to perform a dehumidification process, wherein the tower switching process is performed depending on the flow rate of the humidified gas flowing into the first adsorption tower in which the dehumidification process is performed. The respective processes will now be described. Hereinafter, in describing the respective processes, parts not specifically mentioned are the same as those of the dehumidification apparatus.

[1] Dehumidification Process

Referring to FIG. 2, a dehumidification process (adsorption process) is performed in the first adsorption tower A, and a regeneration process is performed in the second adsorption tower B while the first adsorption tower A performs the dehumidification process.

The compressed air from a compressor, for example, wet compressed air with a relative humidity of 100% is introduced into the first adsorption tower A through the inflow line 10. Specifically, the compressed air is introduced into the first adsorption tower A through the main inflow pipe 12 and the first branch inflow pipe 14A. In FIG. 2, the first inflow valve V14A is opened and the second inflow valve V14B is closed.

The compressed air is dehumidified (dried) by the adsorbent filled inside the first adsorption tower A, and the dry compressed air dehumidified to a certain dew point is discharged through the discharge line 20. The dry compressed air discharged through discharge line 20 is, for example, passed through a filter and then stored in a storage tank, or is supplied to an air header, etc. and used in facilities at various sites.

[2] Regeneration Process

While the dehumidification process is performed in the first adsorption tower A, the regeneration process is performed in the second adsorption tower B. Specifically, the second adsorption tower B maintains the same pressure as the first adsorption tower A for about 5 to 10 seconds, and after the pressure thereof is reduced to atmospheric pressure, the regeneration process is performed. The regeneration process includes a heating step and a cooling step. Additionally, the regeneration process may further include a step for boosting the pressure for a predetermined time.

The regeneration process may be performed in a purge method and/or a non-purge method. Specifically, as described above, the regeneration gas may use dry compressed air or external air, or both. In the present embodiment, descriptions will be made with respect to a case in which dry compressed air is used as a purge by way of example.

(a) Heating Step

In this heating step, the heated regeneration gas is supplied to the second adsorption tower B for dehumidification.

Referring to FIG. 3, some of the dry compressed air dehumidified in the first adsorption tower A is introduced into the regeneration line 30 and supplied to the second adsorption tower B. The dry compressed air is introduced into the dry compressed air inflow pipe 32 connected to the discharge line 20, and thus the flow rate and pressure are appropriately maintained by the flow control valve V32b, the orifice 32B and the pressure reducing valve V32c. The dry compressed air introduced into the dry compressed air inflow pipe 32 passes through the regeneration confluence pipe 35 and is heated by the heater 40 installed in the regeneration confluence pipe 35. The dry compressed air, for example, is heated to a temperature of about 150 to 220° C. by the heater 40 is supplied to the second adsorption tower B through the second supply pipe 38B. In FIG. 3, the first regeneration valve V38A is closed and the second regeneration valve V38B is opened.

The heated dry compressed air desorbs moisture adsorbed to the adsorbent. Thereafter, the compressed air containing the desorbed moisture passes through the second branch inflow pipe 14B and the second purging pipe 16B connected to the second adsorption tower B, and then is discharged into the atmosphere through the silencer 18. Here, in FIG. 3, the first purging valve V16A is closed and the second purging valve V16B is opened.

The heating step may be performed for, for example, 2.0 to 2.5 hours, which may be set by means of a timer of the control unit C.

(b) Cooling Step

In this cooling step, after performing the heating step in the above-described manner, the adsorbent is cooled to restore the function of the adsorbent.

In the case of this cooling step, dry compressed air or external air may also be used, or both may be used. For example, when using dry compressed air, the heating step is performed and then the heating of the heater 40 is turned off. Specifically, some of the dry compressed air dehumidified in the first adsorption tower A is introduced into the regeneration line 30 and supplied to the second adsorption tower B. Here, the dry compressed air is introduced into the dry compressed air inflow pipe 32 connected to the discharge line 20, and thus the flow rate and pressure are appropriately maintained by the flow control valve V32b, the orifice 32B and the pressure reducing valve V32c. The dry compressed air introduced into the dry compressed air inflow pipe 32 is supplied to the second adsorption tower B through the second supply pipe 38B without heating the heater 40 while passing through the regeneration confluence pipe 35.

After the dry compressed air supplied to the second adsorption tower B cools the adsorbent, it passes through the second branch inflow pipe 14B and the second purging pipe 16B as in the heating step, and then passes through the silencer 18 and discharged into the air. The cooling step may be performed for, for example, 1.5 to 2.0 hours, which may be set by means of the timer of the control unit C.

(c) Pressure-Boosting Step

After performing the cooling step, the pressure of the second adsorption tower B is almost the same as atmospheric pressure. Here, when the tower is switched, a pressure difference between the operating pressure and the pressure of the first adsorption tower A is high, which may cause damage to the adsorbent or pressure hunting. To prevent this, the second purging valve V16B is closed and the dry compressed air is introduced into and fills the second adsorption tower B to boost the pressure of the second adsorption tower B to the operating pressure. The pressure-boosting step may be performed for, for example, 2.0 to 5.0 minutes, which may be set by means of the timer of the control unit C.

According to another embodiment of the present invention, in order to reduce energy consumption, the regeneration process (heating and cooling) may be performed in a non-purge manner by using external air as the regeneration gas. Even when external air is used as the regeneration gas, the regeneration process may be performed in the above-described manner.

Specifically, the external air is introduced from the outside through the external air supply means 50, and then the external air is supplied to the second adsorption tower B through the external air inflow pipe 34 and the second supply pipe 38B to perform the regeneration process (heating and cooling). Here, when the external air is used, the external air in the atmosphere has high humidity and low temperature, and thus is not suitable as air for regenerating the adsorbent by itself. Therefore, in the heating step, the external air is heated through the heater 40 installed in the regeneration confluence pipe 35 and is then supplied to the second adsorption tower B for dehumidification. In addition, in the cooling step, since the adsorbent may be moistened again due to the humidity of the external air, for example, the external air is condensed through a cooler to remove moisture in advance, and then supplied to the second adsorption tower B for cooling.

In addition, according to another embodiment of the present invention, in the regeneration process (heating and cooling), the regeneration gas used in the heating step uses the external air introduced from the external air inflow pipe 34, and as the regeneration gas used in the cooling step, the dry compressed air introduced from the dry compressed air inflow pipe 32 may be used, and vice versa.

[3] Standby Process

After performing the pressure-boosting step, a dehumidification process is performed in the first adsorption tower A, while a standby process in which a regeneration process is not performed is performed in the second adsorption tower B. The states of the respective valves V14 to V34 are almost the same as that in the pressure-boosting step, but the regeneration gas is not supplied to the second adsorption tower B. That is, the second adsorption tower B maintains almost the same operating pressure as the first adsorption tower A due to the boosting of pressure, but is in a standby state without a dehumidification or regeneration process.

The standby process is an energy-saving step, in which dry compressed air is produced by performing a dehumidification process in the first adsorption tower A, while there is no consumption of energy (electricity and compressed air) because the regeneration process is not performed in the second adsorption tower B).

Therefore, it can be considered that the longer the standby process time, the greater the energy savings. When designing a dehumidification apparatus, the greater the safety factor and the lower the operation rate of the air compressor, the longer the standby process time may be. The standby process may last, for example, at least 2 hours or more, specifically 2 to 4 hours. This standby process is terminated on the basis of the flow rate measured by the flow meter F.

[4] Tower-Switching Process

Next, towers are switched. That is, the first adsorption tower A is switched to perform a regeneration process, and the second adsorption tower B is switched to perform a dehumidification process. Here, the tower switching is dependent on the flow rate measured by the flow meter F. According to the present invention, a factor that serves as a reference point of the tower switching time is the inflow flow rate measured by the flow meter F, and specifically, the tower is switched depending on the flow rate of the humidified gas flowing into the first adsorption tower A in which a dehumidification process is performed.

According to one embodiment, the control unit C is configured to control the dehumidification process and the regeneration process performed in the first adsorption tower A and the second adsorption tower B are reversely switched depending on the flow rate measured by the flow meter F. The flow meter F is installed in the inflow line 10 to measure the inlet flow rate of the first adsorption tower A. Specifically, the flow meter F is measured by integrating the total inlet flow rate of the first adsorption tower A while the first adsorption tower A performs the dehumidification process. The flow meter F can be reset together with integration, and may be selected from, for example, an electromagnetic flow meter.

In addition, when the preset flow rate and the flow rate measured by the flow meter F are equal to each other, the control unit C transmits a signal to control each of the valves V14A to V34 to switch towers. Here, when towers are switched, the flow meter F may be reset to be initialized to 0 (zero).

According to one embodiment, the control unit C, which is a component for tower switching, may include: a flow rate setting unit for setting a flow rate; a tower switching unit for reversely switching the dehumidification process and the regeneration process performed in the first adsorption tower A and the second adsorption tower B; and a reset signal unit for initializing (resetting) the flow meter F.

An arbitrary flow rate value is input to and set in the flow rate setting unit in advance according to the site situation or operating conditions. In addition, when the flow rate set in the flow rate setting unit and the flow rate measured by the flow meter F are equal to each other, the tower switching unit transmits a signal to control each of the valves V14A to V34.

Specifically, the tower switching unit transmits an electrical signal for switching so as to close the first inflow valve V14A, the first discharge valve V24A, the second regeneration valve V38B, and the second purging valve V16B and to open the second inflow valve V14B, the second discharge valve V24B, the first regeneration valve V38A, and the first purging valve V16A. Here, each of the valves V14A to V34 may include a solenoid valve that is opened and closed by the electrical signal.

Accordingly, the first adsorption tower A is switched to perform a regeneration process, and the second adsorption. When the towers are switched in this way, the reset signal unit sends a signal to the flow meter F for initialization. That is, after tower switching, the flow meter F receives a signal from the reset signal unit and is initialized, and measures the flow rate of the second adsorption tower B, starting from zero again.

Meanwhile, according to another embodiment of the present invention, the tower switching may be performed depending on the dew point for stability. Specifically, in preparation for malfunction or failure of the flow meter F, the control unit C may control the tower to be switched on the basis of a preset dew point and a dew point measured by the dew-point meter D. That is, when the dew point measured by the dew-point meter D is below the preset dew point, the tower is switched in preparation for an emergency. In this case, a warning light may be turned on to inform the driver of danger.

The dew-point dependent tower switching is preparation for emergency for stability and is primarily dependent on the flow rate. That is, the control unit C primarily controls tower switching depending on the flow rate of the flow meter F, and secondarily controls tower switching depending on the dew point of the dew-point meter D in the event of an emergency, such as malfunction or failure of the flow meter F.

Meanwhile, in the present invention, the respective lines 10, 20, and 30 and the pipes 12 to 34 are not particularly limited as long as a flow path through which a gas (compressed air, etc.) can pass can be provided. In addition, the respective lines 10, 20, and 30 and the pipes 12 to 34 may be made of a material selected from, for example, a metal material and/or a synthetic resin material, and may be rigid and/or flexible.

According to the above-described present invention, the moisture contained in the moisture-containing gas, such as compressed air, is dried through adsorption and regeneration, and the dehumidification process (adsorption process) and the regeneration process are switched depending on the flow rate of gas flowing into the adsorption towers A and B, and thus at least the renewable energy consumed in the regeneration process can be reduced and the utilization of the adsorbent can be improved.

As mentioned above, the adsorption dehumidification apparatus installed in almost all sites is designed and manufactured to dry and produce a larger amount of compressed air than the actual amount used. In addition, as described above, in the regeneration process (heating and cooling), some of designed yield is designed to be used as a regeneration gas.

For example, it is assumed that the designed yield of the dehumidification apparatus is 10,000 Nm³/hr, and the actual usage is 8,000 Nm³/hr, which is 80% of the designed yield. In addition, it is assumed that the regeneration gas used in the regeneration process is 1,000 Nm³/hr, which is 10% of the designed yield. In this case, in the regeneration process, 10% of the compressed air production energy (that is, the energy required to compress the air in the atmosphere in a compressor, etc.) is required, and the power energy for the heater 40 to heat the regeneration compressed air of power energy is additionally required. In addition, assuming that the power energy of the heater 40 is 50 kW, the renewable energy corresponding to the sum of 10% of the compressed air production energy and 50 kW of the power energy for the heater 40 is consumed in the regeneration process (heating and cooling).

Here, as in the prior art, when tower switching is performed in a time-dependent manner, the amount of adsorbent filled in the adsorption towers A and B is fixed to a predetermined amount that is initially designed, and regeneration should be performed for a time corresponding to the filling amount of the adsorbent. However, in actual industrial sites, there are cases where the operation needs to be reduced according to the field conditions or operating conditions of the factory. Even in such a case, since the initially designed filling amount of adsorbent is constant, the initially designed regeneration energy is required for regeneration regardless of the reduction in operation. As described above, in the prior art, even when the operation needs to be reduced, the consumption of renewable energy does not change, and more renewable energy than necessary is consumed.

In addition, the utilization of the adsorbent is lowered. That is, even though the adsorbent filled in the adsorption towers A and B where the dehumidification is performed still has dehumidification performance, even though the adsorbent filled in the adsorption tower (dehumidification tower) of the dehumidification process still has dehumidification performance, tower switching is performed by a predetermined time and regeneration is performed in a state where the regeneration performance is not fully achieved.

However, according to the present invention, as described above, when the operation needs to be reduced according to the site situation or operating conditions of a factory, if the flow rate set in the control unit C is low, tower switching is performed depending on the set flow rate and the flow rate measured by the flow meter F, and thus the renewable energy can be reduced. That is, since tower switching is performed depending on the set flow rate that can be set by a user or operator according to circumstances and the flow rate of gas flowing into the first adsorption tower A, an unnecessary regeneration process is not performed in the second adsorption tower B, thereby preventing the renewable energy from being consumed.

Specifically, according to the present invention, when the actual amount of dried gas used in the field is smaller than the designed yield of the adsorption-type dehumidification apparatus and the operation needs to be reduced, that is, when the actual usage that is actually required at the site is reduced due to changes in the site conditions or operating conditions of factory, etc., the flow rates of the moisture-containing gas flowing into the adsorption towers A and B, where the dehumidification process is performed, are measured through the flow meter F, the dehumidification process and the regeneration process are switched through the control unit C depending on the flow rate of the inflow moisture-containing gas, measured by the flow meter F, thereby reducing the renewable energy consumed in the regeneration process.

In addition, in terms of the utilization of adsorbent, in the case of a time-dependent tower switching, as in the prior art, tower switching is performed even though the adsorbent still has dehumidification performance, the dehumidification process is allowed to be performed until the performance of adsorbent is exhausted. Specifically, according to the present invention, if the flow rate is set in consideration of the performance and lifespan of the adsorbent, the performance of the adsorbent can be mostly utilized, and the lifespan of the adsorbent can also be extended, and the replacement time of the adsorbent can be predicted.

### INDUSTRIAL APPLICABILITY

The present invention can be applied to, for example, industrial equipment by using dry compressed air. According to the present invention, depending on the flow rate of inflow compressed air that can be arbitrarily set by a user (operator), the tower switching of the dehumidification apparatus can be performed in a flow-dependent switching method. Accordingly, the actual production can be designed in a smart manner according to the actual field situations or operating conditions of factory, and renewable energy, which is useful industrially, can be reduced.

1. An adsorption-type dehumidification apparatus of moisture-containing gas, comprising:
a first adsorption tower (A) and a second adsorption tower (B) which are two adsorption towers filled with adsorbents and which alternately perform a dehumidification process and a regeneration process;
an inflow line (10) for introducing a humidified gas into the first adsorption tower (A) and the second adsorption tower (B);
a discharge line (20) for discharging a dried gas dehumidified in the first adsorption tower (A) and the second adsorption tower (B);
a regeneration line (30) for introducing a regeneration gas into the first adsorption tower (A) and the second adsorption tower (B);
a heater (40) for heating the regeneration gas;
a flow meter (F) for measuring the flow rate of the humidified gas flowing into the first adsorption tower (A) and the second adsorption tower (B); and
a control unit (C),
wherein the control unit (C), depending on the flow rate measured by the flow meter (F), switches the dehumidification process and the regeneration process.

2. The adsorption-type dehumidification apparatus of claim 1, wherein the control unit (c) comprises:
a flow rate setting unit for setting a flow rate;
a tower switching unit for reversely switching the dehumidification process and the regeneration process performed in the first adsorption tower (A) and the second adsorption tower (B); and
a reset signal unit for initializing the flow meter (F).

3. A dehumidification method of a moisture-containing gas, which uses the adsorption-type dehumidification apparatus of claim 1, and comprises:
a dehumidification process performed in the first adsorption tower;
a regeneration process performed in the second adsorption tower (B) while the dehumidification process is performed in the first adsorption tower (A);
a standby process in which a dehumidification process is performed in the first adsorption tower (A), but a regeneration process is not performed in the second adsorption tower (B); and
a tower switching process in which the first adsorption tower (A) is switched to perform a regeneration process, and the second adsorption tower (B) is switched to perform a dehumidification process,
wherein the tower switching process is performed depending on the flow rate of the humidified gas flowing into the first adsorption tower (A) in which the dehumidification process is performed.

4. A dehumidification method of a moisture-containing gas for producing a dried gas by adsorbing and removing moisture contained in the moisture-containing gas by using an adsorption-type dehumidification apparatus comprising two adsorption towers (A and B), in which the dehumidification process and the regeneration process are alternately and continuously performed through the two adsorption towers (A and B), the dehumidification method comprising:
a process for performing a dehumidification process in one of the two adsorption towers (A and B) and a regeneration process in the other of the adsorption towers (A and B); and
a tower switching process for switching the dehumidification process and the regeneration process performed in the two adsorption towers (A and B),
wherein the adsorption-type dehumidification apparatus comprises:
a first adsorption tower (A) and a second adsorption tower (B) which are two adsorption towers filled with adsorbents and which alternately perform a dehumidification process and a regeneration process;
an inflow line (10) for introducing a humidified gas into the first adsorption tower (A) and the second adsorption tower (B);
a discharge line (20) for discharging a dried gas dehumidified in the first adsorption tower (A) and the second adsorption tower (B);
a regeneration line (30) for introducing a regeneration gas into the first adsorption tower (A) and the second adsorption tower (B);
a heater (40) for heating the regeneration gas;
a flow meter (F) for measuring the flow rate of the humidified gas flowing o the first adsorption tower (A) and the second adsorption tower (B); and
a control unit (C),
wherein the control unit (C), depending on the flow rate measured by the flow meter (F), switches the dehumidification process and the regeneration process, and
the regeneration process comprises:
a heating step in which the regenerated gas heated through the heater (40) is supplied to the adsorption towers (A and B) to desorb the moisture adsorbed into the adsorbent; and
a cooling step in which, after the heating step, the adsorbent is cooled by supplying the regeneration gas to the adsorption towers (A and B), and
the tower switching process reduces the renewable energy consumed in the regeneration process, such that when the actual amount of dried gas used in the field is smaller than the designed yield of the adsorption-type dehumidification apparatus and the operation needs to be reduced, the flow rate of the moisture-containing gas flowing into the adsorption towers (A and B), where the dehumidification process is performed, is measured by the flow meter (F), the dehumidification process and the regeneration process are switched through the control unit C.

5. The dehumidification method of claim 4, wherein the regeneration line (30) comprises:
a dry compressed air inflow pipe (32) for introducing some of the dried gas dehumidified in the adsorption towers (A and B);
an external air inflow pipe (34) for introducing external air;
supply pipes (38A and 38B) for supplying the regenerated gas introduced into the dried gas inflow pipe (32) and the external air inflow pipe (34) to the adsorption towers (A and B); and
a regeneration confluence pipe (35) through which the dry compressed air inflow pipe (32) and the external air inflow pipe (34) are joined, and which is connected to the supply pipes (38A and 38B),
wherein: the heater (40) is installed in regeneration confluence pipe (35);
in the heating step of the regeneration process, the external air introduced into the external air inflow pipe (34) is used as a regeneration gas, the external air is heated through the heater (40) installed in the regeneration confluence pipe (35), and then supplied to the adsorption towers (A and B) to desorb the moisture adsorbed into the adsorbent; and
in the cooling step of the regeneration process, the dried gas introduced into the dried gas inflow pipe (32) is used as a regeneration gas, the dried gas is supplied to the adsorption towers (A and B) without heating the heater (40) to cool the adsorbent.

6. The dehumidification method of claim 4, wherein the control unit (c) comprises:
a flow rate setting unit for setting a flow rate;
a tower switching unit for reversely switching the dehumidification process and the regeneration process performed in the first adsorption tower (A) and the second adsorption tower (B); and
a reset signal unit for initializing the flow meter (F), and
the regeneration line (30) comprises:
a dry compressed air inflow pipe (32) which is connected to the discharge line 20 and introduces some of the dried gas dehumidified in the adsorption towers (A and B);
a flow control valve (V32b) installed in the dry compressed air inflow pipe (32);
an orifice (32B); and
a pressure reducing valve (V32c),
wherein in the heating step and the cooling step of the regeneration process, the dried gas introduced into the dried gas inflow pipe (32) is used as a regeneration gas, and the dried gas is pressure-reduced to 1.0 to 3.0 kg/cm² and then supplied to the adsorption towers (A and B).

7. The dehumidification method of claim 4, wherein the dehumidification apparatus further comprises a dew-point meter (D) for measuring the dew point of the dried gas by sampling the dried gas discharged to the discharge line (20), and
the dehumidification process and the regeneration process are switched in the tower switching process depending on the flow rate of the inflow moisture-containing gas, measured by the flow meter (F),
wherein in the event of a malfunction or failure of the flow meter (F), the dehumidification process and the regeneration process are switched through the control unit (C) based on the dew point of the dried gas measured by the dew-point meter (D), and thus the renewable energy consumed in the regeneration process is reduced.
